(19) United States
(12) Patent Application Publication
(10) Pub. No.: US 2004/0055832 A1
(43) Pub. Date: Mar. 25, 2004

(54) Electronic parking brake with feedback control and cable strain gage

(75) Inventor: Daniel Robert Mercer, Clarkston, MI (US)

Correspondence Address: DAVIDSON, DAVIDSON & KAPPEL, LLC, 485 SEVENTH AVENUE, 14TH FLOOR, NEW YORK, NY, 10018, US

(73) Assignee: Edscha North America, Southfield, MI

(21) Appl. No.: 10/455,493

(22) Filed: Jun. 5, 2003

Related U.S. Application Data
(60) Provisional application No. 60/412,041, filed on Sep. 19, 2002.

(51) Int. Cl. B60T 13/72; B60T 15/14

(52) U.S. Cl. 188/2 D; 303/20

(57) ABSTRACT

A parking brake system for a vehicle with a brake device for braking the vehicle, at least one cable actuating the brake device, and a motor actuating the cable. A strain gage is connected to the cable, the strain gage having an output, the strain gage output being a function of a strain in the cable. A controller receives an input from the strain gage output, the controller controlling the motor as a function of the strain gage output. In addition, a strain gage for an actuation cable in a vehicle includes a coil surrounding the cable, the coil having a diameter varying as a function of a force on the cable, and a circuit. The circuit includes a voltage supply for providing a voltage across the coil and a detector for measuring electrical changes in the circuit as a function of the diameter of the coil.

### CROSS-REFERENCE TO RELATED APPLICATIONS

This application claims priority to U.S. provisional application Serial No. 60/412,041, filed on Sep. 19, 2002.

### BACKGROUND OF THE INVENTION

The present invention relates generally to vehicles and more particularly to electronically-controlled cable-actuated systems in vehicles.

U.S. Pat. No. 5,086,662 discloses a parking brake device for an automobile. The parking brake device has a reaction conduit system in which a parking brake operating lever is connected to a right rear wheel brake via a primary cable. A reaction conduit surrounds the primary cable, so that when the primary cable straightens upon actuation of the parking brake operating lever, the reaction conduit compresses, forcing a floating reaction bracket to pull a secondary cable to operate the left rear wheel brake.

U.S. Pat. No. 6,213,259 discloses an electronically powered parking brake. The parking brake has an electronic control module for a motor connected to a primary parking brake cable. The control module activates the parking brake by having the motor retract the cable until the current of the motor reaches a predetermined current. The parking brake has a current sensor to determine the current drawn by the electric motor, and a cable motion sensor for sensing an amount of change in the position of the primary cable. Upon release of the parking brake, the motor is reversed and feeds out the cable a predetermined amount based on a reading of the cable motion sensor.

If the motor current does not accurately reflect tension in the cable, for example by a malfunctioning of the motor, the brake disclosed is U.S. Pat. No. 6,213,259 may not apply a proper tension to the cable, which could lead to a malfunctioning of the brake. In addition, the current of the motor does not provide an accurate measurement of tension when the cable is being released or when the motor is stopped, so that a cable motion sensor is necessary for determining the release amount.

Both U.S. Pat. Nos. 5,086,662 and 6,213,259 are hereby incorporated by reference herein.

### SUMMARY OF THE INVENTION

An object of the present invention is to provide a reliable electronic parking brake.

Another alternate or additional object is to permit accurate sensing of vehicle cable tension, and control thereof.

Yet another alternate or additional object of the present invention is to provide an electronic parking brake in which a cable distance sensor is not necessary.

The present invention provides a parking brake system for a vehicle comprising:

a brake device for braking the vehicle;

at least one cable actuating the brake device;

a motor actuating the cable;

a strain gage connected to the cable, the strain gage having an output, the strain gage output being a function of a strain in the cable; and

a controller receiving an input from the strain gage output, the controller controlling the motor as a function of the strain gage output.

Strain gage as defined herein is any device that senses a variable as a function of the strain, stress or force on the cable directly on or at the cable.

Preferably, the cable includes a primary cable and a secondary cable, and the brake device includes a first wheel brake and a second wheel brake. The primary cable then connects the motor directly to the first wheel brake and the secondary cable is directly connected to the second wheel brake. Preferably, the secondary cable is connected to the primary cable via a reaction bracket, and the primary cable is surrounded at least partially by a reaction conduit.

Preferably, the strain gage is connected to the secondary cable, although it may be connected to the primary cable

A strain gage for both the primary and secondary cable may be provided. The strain gage preferably is a bonded strain gage directly bonded to the cable.

Alternately, the strain gage may be an inductor strain gage, with a coil surrounding the cable, the coil moving away from the cable as a function of the strain on the cable. Preferably, the coil is embedded in a reaction conduit surrounding the cable.

In a normal static operating mode, the controller may determine an actuation setpoint as a function of a desired cable strain, and the controller then causes the motor to retract the cable until the setpoint is reached.

The desired cable strain may be the function of other inputs to the controller, including vehicle weight and grade. The setpoint alternately may be predetermined, for example to provide a cable strain capable of holding a fully-loaded vehicle at its rated maximum weight stationary at a maximum required grade. Thermal compensation may also be added, so that the setpoint varies as a function of temperature to compensate for strain gage differences related to temperature.

The controller also may receive inputs from other devices, including a vehicle speed sensor, an ABS system, and a gearshift selector position. A cable travel sensor may also provide an input.

For static operation, if the controller determines that the vehicle is at rest, or underneath a given speed threshold, the controller then may apply the parking brake until the cable reaches the desired strain or force threshold or setpoint.

An extra amount preferably is added to the threshold or setpoint to account for brake wear or to ensure performance.

Once the controller determines that the desired setpoint has been reached, the controller may poll the speed sensors to determine the speed of travel again (or to determine a park position of the gearshift selector if the automobile has an automatic transmission). The controller also may poll the cable travel sensor to determine if the cable has traveled within a normal operating parameter. If the vehicle is not moving, and the cable travel is within normal operating parameters, the controller will activate the parking brake indicator light on an instrument panel.

If the vehicle speed sensors do not indicate that the vehicle is stopped, or the cable travel is outside its normal operating parameters, the controller will indicate a fault code to the controller and apply the motor to the pull the cable to its limit, or until the speed sensors indicate a stopped condition.

The controller may also monitor other fault conditions, including a temperature out of range, no strain gage signal or a strain gage signal out of range, no speed sensor signal or a speed sensor signal out of range, a supply voltage out of range, and no transmission selector signal.

To release the parking brake system, the operator can indicate a release, for example by activating a release button, switch or handle, the controller then causes the motor to feed out the cable to a release setpoint, i.e. until the strain gage falls to a certain strain or force. The cable thus may remain slightly pretensioned, preventing flapping or other undesirable conditions.

Advantageously, the strain gage is used to control the release, rather than relying on a separate cable movement sensor.

The parking brake can also be used for dynamic stopping, i.e. to supplement normal or ABS braking or replace failed normal braking, by permitting an operator to apply the parking brake. In this case, the controller retracts the cable as far as it is capable for as long as the switch is applied. The controller determines that the dynamic stopping is desired based on the vehicle speed sensors and transmission selector position. If the vehicle speed is above a certain amount and the transmission selector is in drive, for example, a dynamic stopping condition is determined and the controller actuates the motor to retract the cable. Once the switch is released, the controller reverses the motor to the predetermined force required for the pretensioning, as with the static mode.

An ABS system can also be used to determine if lock-up conditions are occurring during dynamic stopping, in which case the controller can apply and release the parking brake to prevent lock-up even while the operator is pressing the parking brake to cause dynamic stopping.

The present invention also provides a method for controlling an automatic parking brake comprising:

directly sensing a parking brake cable so as to determine a variable as a function of a strain in the cable;

feeding back the variable to a controller of a parking brake cable; and

operating a motor, the motor actuating the cable as a function of the variable.

Preferably, the motor retracts the cable until the variable reaches a setpoint, the setpoint being a function of a desired strain in the cable. The stepoint preferably is a function of a maximum rated automobile weight and slope grade.

The present invention also provides a strain gage for a cable comprising a:

a coil surrounding the cable, the coil having a diameter varying as a function of a force on the cable; and

an electric circuit, the circuit including a voltage supply for providing a voltage across the coil and a detector for measuring electrical changes in the circuit as a function of the diameter of the coil.

Preferably, the coil is part of a reaction conduit surrounding the cable.

Inductance for a helical coil varies as a radius of the coil and the number of turns in the coil, as may be estimated for an air core as I=0.394r²xN²/(9r+10L), where I is inductance in microhenrys, r is the radius of the coil in centimeters, N are the number of turns in the coil and L is the length of the coil in centimeters. Since the coil radius is a function of the force on the cable, the coil and the cable function as variable inductor due to the fact that the radius varies. Thus, the inductance of the cable will vary as the strain on the cable varies. The relationship between the strain and the inductance can be determined by testing with a specific embodiment and will vary depending on length of the coil, number of turns, the materials used for the coil and the wire, which affects the permeability of the interior of the helical coil, and thus affects the above estimated equation used for air cores. Once the relationship is determined, the inductance determined using the circuit may be used as a representation of the strain.

Preferably, a voltage supply for the detector is an A-C voltage supply, and the circuit includes an inductance meter. The inductance meter may include a Maxwell-Wien bridge, having variable resistors and a capacitor.

The feedback control of the vehicle cable and the coil and inductance strain gage of the present invention are not limited to use in parking brakes, and may be used for other cable-operated vehicle systems including automatic spare tire carriers, window regulators, throttle assemblies, shifter systems, or aerospace filght control surface actuators.

Voltage for the various elements in the parking brake system may be supplied by the vehicle battery.

### BRIEF DESCRIPTION OF THE DRAWINGS

The present invention itself, both as to its construction and its mode of operation, together with additional advantages and object thereof, will be best understood from the following detailed description, in which:

FIG. 1 shows a schematic view of a parking brake system for a motor vehicle according to the present invention; and

FIG. 2 shows a view of a strain gage according to the present invention.

### DETAILED DESCRIPTION OF THE PREFERRED EMBODIMENT

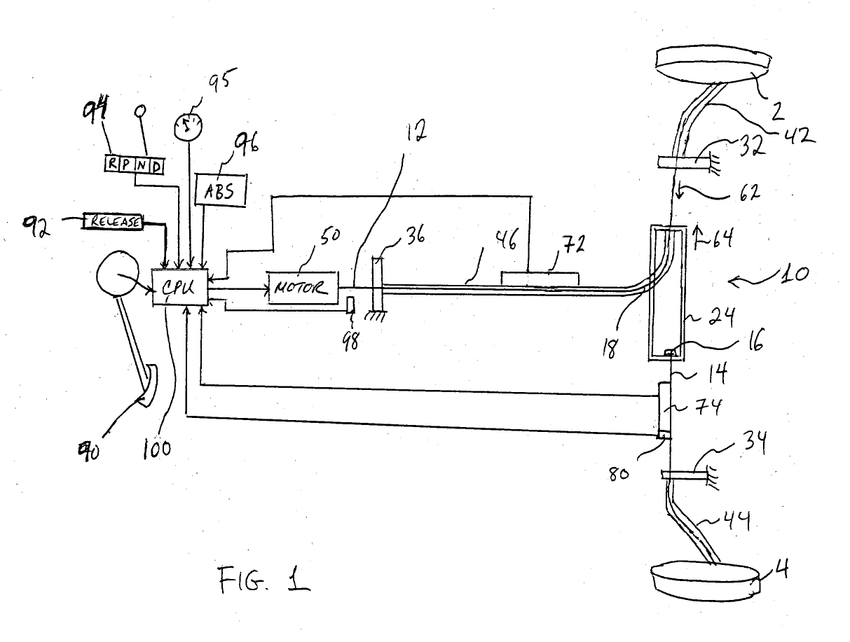

FIG. 1 shows a schematic view of a parking brake system for a motor vehicle according to the present invention, for use with a conduit reaction parking brake 10 for a right wheel brake 2 and a left rear brake 4. Parking brake 10 includes a primary cable 12 driven by a reversible motor 50, the primary cable 12 being connected to the right rear wheel brake 2. A reaction conduit 46 surrounds the primary cable 12 at least around a bend 18 of cable 12. Reaction conduit 46 and cable 12 are supported at one end by a support 36, which may be fixed to the vehicle body. Another conduit 42 and support 32 can support the cable 12 near the right rear wheel brake 2.

Reaction conduit 46 acts upon a floating reaction bracket 24, so that when motor 12 pulls cable 12 in direction 62, cable 12 straightens, causing reaction conduit 46 to compress between support 36 and bracket 24, and thus forcing bracket 24 in direction 64. Fixed to reaction bracket 24 is a secondary cable 14 connected to the second wheel brake 4 to actuate the second wheel brake 4. Another conduit 44 and support 34 can support cable 14.

Motor 50 thus can retract cable 12 to operate both wheel brakes 2 and 4, which may be for example rear wheel brakes for an automobile. Motor 50 is reversible, so that the cable 12 can also be fed out to release wheel brakes 2 and 4, and may include a linear electromechanical actuator powered by a permanent magnet or brushless DC motor, so that rotation and torque are converted into a linear force and displacement using gears.

Motor 50 is controlled by a controller 100, for example a microprocessor.

Controller 100 receives inputs from a parking brake actuator 90, shown schematically as a pedal for clarity, but also possible to be implemented as a button or other device. A release 92, for example a handle or other button, may also be provided. A gearshift selector 94, speed sensor 95, and an ABS brake system 96 provide further inputs to the controller 100.

A cable motion detector 96 can be used to determine a movement or position of the cable 12, and feed this information to the controller 100.

In the embodiment shown, secondary cable 14 has a strain gage 74 bonded to cable 14 over a length of the cable, for example by epoxy, and the strain gage may be a semiconductor resistance strain gage. The output of the strain gage 74 is fed to the controller 100. A temperature sensor 80 can also be provided, preferably located near the strain gage 74, to provide for compensation for temperature variations on the output of strain gage 74, although bonded resistance strain gages generally are only moderately affected by temperature changes.

If only a single strain gage is provided, which may be preferable for cost reasons, the single strain gage 74 preferably is located on the secondary cable 14. Failure or problems in either cable 12 or cable 14 can be detected, since a failure or problem in cable 12 will cause failure or problems in cable 14 via reaction bracket 24.

As an alternate or addition to a bonded resistance strain gage 74, an inductance strain gage according to the present invention may be provided, and is shown in the embodiment of FIG. 1 on the primary cable 12 as inductance strain gage 72.

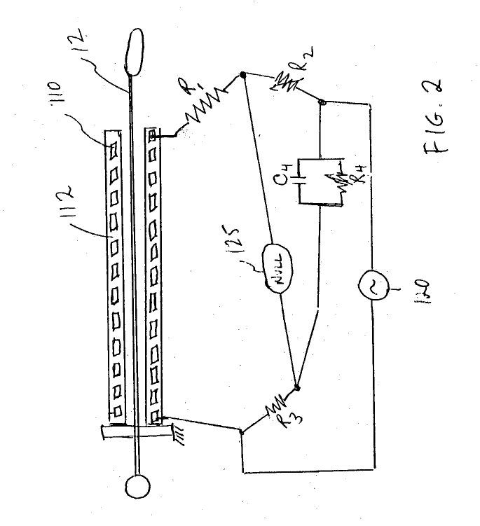

As shown in FIG. 2, reaction conduit 46 has a metal coil 110 wrapped inside a polyurethane cover 112, as is typical in reaction conduit brake systems. As the reaction conduit 46 compresses when motor 50 pulls cable 12, the effective diameter of the coil 110 varies. Since the coil 110 about the cable 12 is a helical coil, inductance changes as the radius of the coil 110 varies. Preferably, the entire reaction conduit 46 with coil 110 is used, so that the number of turns of coil and length is maximized, which can increase sensitivity to radius changes.

In order to measure the inductance change, a commercially available inductance meter may be used, and may output a variable corresponding to the inductance to the controller 100. FIG. 2 shows schematically a Maxwell-Wien bridge for measuring the inductance in the coil using an alternating current source 120. Variable resistors R2 and R4 are provided, and fixed resistors R1 and R3. A capacitor C4 is in parallel with resistor R4. A null detector 125 is provided, as for example used in a Wheatstone bridge. The inductance in the coil 110 can be measured by the equation R2*R3*C4, when R1=R2*R3/R4.

The FIG. 2 schematic is displayed to show the principle behind most commercially-available inductance meters, which typically are more complicated, but can provide a variable representative of inductance that can be fed directly to controller 100.

The strain gage 72, which may be an inductance meter for the coil in reaction conduit 46, thus can provide an additional strain measurement for controller 100. Preferably however a single strain gage is used.

The brake system may function as follows for static parking:

Controller 100 has a predetermined actuation setpoint corresponding to a desired strain in the cable 14. The actuation setpoint is a function of maximum vehicle weight and parking slope grade, and may include a buffer for errors. For example, the controller will desire to set a force of about 900 Newtons to the brake arm at each rear wheel brake 2, 4, even though the force necessary to hold the automobile stable under maximum grade and weight conditions is 850 Newtons. Thus variations caused by brake wear, temperature, strain gage errors, or other errors can be compensated for.

The release setpoint will be set at a strain corresponding to a predetermined tension in the cable 14, for example, at 10-20 Newtons, which can prevent the cable 14 from flapping while leaving the brake released.

When an operator actuates the parking brake actuator 90, the controller 100 then checks the vehicle speed from speed sensor 95 to ensure the vehicle is at a standstill or barely moving. The controller then actuates motor 50 to pull cable 12. Sensor 74 then measures the strain in cable 14 and feeds back this information to controller 100. Once the desired actuation setpoint is reached, for example to one corresponding to 900 Newtons, the controller 100 checks the vehicle speed again to ensure the vehicle is now stopped and then stops motor 50. If the vehicle is not stopped, the controller 100 can direct the motor 50 to increase the strain in cable 14 past the actuation setpoint, to a maximum level of the motor 50 or until the vehicle stops.

Upon release of by an operator of the parking brake using release 92, the motor 50 feeds out the cable 12 until the strain in cable 14 falls to the release setpoint. Thus, both the actuation and release of the brake system are controlled by a direct strain measurement.

The cable motion sensor 98 can be used to ensure that travel of the cable 12 is within a normal operating range. If not, an error message can be given.

If the parking brake is desired to be used during a dynamic apply and release, the controller can be set to permit such action. When the parking brake is then activated and the speed of the vehicle is above a threshold, and for example if the automobile has an automatic transmission in drive, neutral or reverse, the motor 50 is driven for as long as the operator holds down lever or activation switch 90. The tension and strain in cable 14 thus increases to the limits of the motor 50. When the operator releases the lever 90, the tension and strain are reduced to the release setpoint as in static mode.

The operator thus can use the parking brake as an additional or back-up brake during operation. ABS system 96 can also be queried so that if lock-up occurs while the lever or actuator 90 is depressed, the brakes 2, 4 can release and reapply in succession to prevent lock-up, as in a normal ABS system.

Preferably, the strain gage error is less than 5%, easily achievable by bonded resistance strain gages even with temperature variations. However, thermal compensation may be provided.

What is claimed is:

1. A parking brake system for a vehicle comprising:
a brake device for braking the vehicle;
at least one cable actuating the brake device;
a motor actuating the cable;
a strain gage connected to the cable, the strain gage having an output, the strain gage output being a function of a strain in the cable; and
a controller controlling the motor and receiving an input from the strain gage output, the controller controlling the motor as a function of the strain gage output.

2. The system as recited in claim 1 wherein the at least one cable includes a primary cable and a secondary cable, and the brake device includes a first wheel brake and a second wheel brake, the primary cable connecting the motor directly to the first wheel brake and the secondary cable being connected directly to the second wheel brake.

3. The system as recited in claim 2 further comprising a reaction bracket and a reaction conduit, the secondary cable being connected to the primary cable via the reaction bracket and the primary cable being surrounded at least partially by the reaction conduit.

4. The system as recited in claim 2 wherein the strain gage is connected to the secondary cable.

5. The system as recited in claim 1 wherein the strain gage is a bonded strain gage directly bonded to the cable.

6. The system as recited in claim 1 wherein the strain gage is an inductor strain gage, the strain gage including a coil surrounding the cable.

7. The system as recited in claim 6 further comprising a reaction conduit surrounding at least part of the cable, the coil being part of the reaction conduit.

8. The system as recited in claim 1 wherein a radius of the coil varies as a function of a strain in the cable.

9. The system as recited in claim 1 further comprising an actuator for an operator connected to the controller, the controller having an actuation setpoint, the controller retracting the cable upon receipt of an actuation signal from the actuator until the strain gage output reaches a value corresponding to the actuation setpoint.

10. The system as recited in claim 9 further comprising a release for an operator connected to the controller, the controller having a release setpoint, the controller feeding out the cable upon receipt of a release signal from the release until the strain gage output falls to a value corresponding to the release setpoint.

11. The system as recited in claim 1 further comprising a vehicle speed sensor connected to the controller.

12. The system as recited in claim 1 further comprising an ABS system and a gearshift selector position connected to the controller.

13. The system as recited in claim 1 further comprising a cable travel sensor connected to the controller for determining a travel in the cable.

14. A cable-tension control system for a vehicle comprising:
a device for operating a part of the vehicle;
at least one cable actuating the operating device;
a motor actuating the cable;
a strain gage connected to the cable, the strain gage having an output, the strain gage output being a function of a strain in the cable; and
a controller controlling the motor and receiving an input from the strain gage output, the controller controlling the motor as a function of the strain gage output.

15. A method for controlling an automatic parking brake comprising:
directly sensing a parking brake cable so as to determine a variable as a function of a strain in the cable;
feeding back the variable to a controller of a parking brake cable; and
operating a motor, the motor actuating the cable as a function of the variable.

16. The method as recited in claim 15 further comprising determining an actuation operation of an operator, the operating step including retracting the cable when an actuation operation is determined until the variable reaches an actuation setpoint, the setpoint being a function of a desired strain in the cable.

17. The method as recited in claim 16 wherein the actuation setpoint is a function of a maximum rated automobile weight and slope grade.

18. The method as recited in claim 15 further comprising determining a release operation of the operator, the operating step including feeding out the cable when the release operation is determined until the variable falls to a release setpoint.

19. The method as recited in claim 15 further comprising sensing a vehicle speed and determining an actuation operation of an operator, the operating step including retracting the cable when an actuation operation is determined, and, if the speed is above a certain threshold, retracting the cable to a maximum capacity of the motor for as long as the actuation operation continues.

20. A strain gage for an actuation cable in a vehicle comprising a:
a coil surrounding the cable, the coil having a diameter varying as a function of a force on the cable; and
an electric circuit, the circuit including a voltage supply for providing a voltage across the coil and a detector for measuring electrical changes in the circuit as a function of the diameter of the coil.

21. The strain gage as recited in claim 20 wherein the coil is part of a reaction conduit surrounding the cable.

22. The strain gage as recited in claim 20 wherein the detector is an inductance detector.
